(19) United States
(12) Patent Application Publication
(10) Pub. No.: US 2011/0191124 A1
(43) Pub. Date: Aug. 4, 2011

(54) RFID-BASED SYSTEM FOR LINKING ELECTRONIC MEDICAL RECORD

(76) Inventors: Myung-Whun Sung, Seoul (KR); Kwang-Suk Park, Seoul (KR); Chung-Hyeon Kim, Seoul (JP)

(21) Appl. No.: 13/058,353

(22) PCT Filed: Jun. 8, 2009
(86) PCT No.: PCT/KR09/03054

§ 371 Date: Apr. 25, 2011

(30) Foreign Application Priority Data
Aug. 11, 2008 (KR) 10-2008-0078340

(51) Int. Cl. G06Q 50/00; G06Q 10/00

(52) U.S. Cl. 705/3

(57) ABSTRACT

An RFID-based EMR linking system is disclosed. The location of a patient who has a tag is tracked using RTLS and the tracked location of a patient is linked to EMR so that location information of a patient is detected in real time and moving line and location of a patient may be easily managed.

### TECHNICAL FIELD

The present invention relates to a patient record system of a hospital and, more particularly to a radio frequency identification (RFID) system for monitoring patients

### BACKGROUND ART

RFID is a technology that detects electronic tags attached to stuffs or human in few centimeters or meters to exchange information, and is used in various purposes according to frequencies emitted from the electronic tags. According to a report, the global market of RFID stuffs grows up to 460 million dollars in 2007 by 45% annually from 2002. The RFID technology may be used in managing a hospital such that safety of patients and easy tracking of medicine may be improved.

Meanwhile the electronic medical record (hereinafter, referred to as ‘EMR’) is defined as an electronic record about a patient to provide complete and precise data for a patient and necessary information to a health care provider such that the health care provider may easily make a clinical decision. That is, the EMR is a computer-based health managing system for storing medical information in the electronic formation.

As development of the RFID technology, a system for monitoring a location of a patient in real time and for linking the location to the EMR to provide innovative medical service is demanded.

### DISCLOSURE

### [Technical Problem]

Therefore, the present invention has been made in view of the above problems, and it is an aspect of the present invention to provide an RFID-based EMR linking system for detecting location information of a patient using a real-time locating system (hereinafter, referred to as ‘RTLS’) and to manage the moving line or location of the patient.

### [Technical Solution]

In accordance with an aspect of the present invention, the above and other objects may be accomplished by the provision of an RFID-based EMR linked apparatus including: a receiver receiving patient information about a patient and tag information mapped to the patient information, and receiving location information of the tag possessed by the patient that is detected by an RFID through a network; an extractor extracting location information of respective patients based on the location information of the tag; and a transmitter transmitting the location information of the respective patients through the network.

Here, the RFID-based EMR linked apparatus may further include a storage storing the location information and reservation information of the respective patients; and a searching unit searching for the reservation information of a patient based on the location information of the respective patients.

The present invention also provides an RFID-based EMR linking system linked to an EMR server for storing EMRs of patients and an RTLS server for acquiring location information of patients based on RFID through a network, the system including: a receiver receiving the location information of a patient who enters a health screening room from the RTLS server; and a controller, based on the location information of the patient received by the receiver, searching for reservation information of a corresponding patient from the EMR server to link the searched reservation information to EMR of the corresponding patient.

In this case, the RFID-based EMR linking system may further include a display unit displaying the EMR to a health screener, and the controller controls the display unit to display the patient who enters the health screening room on the EMR of the display unit using the location information of the patient.

The present invention also provides an RFID-based EMR linking system linked to an EMR server for storing EMRs of patients and an RTLS server for acquiring location information of patients based on RFID through a network, the system including: a receiver receiving the location information of a patient from the RTLS server; a controller, based on the location information of the patient received by the receiver, controlling a display unit to display the location of the patient in a hospital; and the display unit displaying the location of the patient under the control of the controller to be seen to a manager. The present invention also provides an RFID-based EMR linking system including: an

RFID unit receiving a wireless signal from an RFID tag possessed by a patient and transmitting location information of the RFID tag; an EMR server storing EMRs of patients; an RTLS server acquiring location information of a patient based on the location information received by the RFID unit; a health screening room PC automatically detecting a patient who enters a heal screening room using the location information of the patient acquired by the RTLS server;

and a manager PC tracking the location of the patient using the location information of the patient acquired by the RTLS server; wherein the RTLS server includes: a receiver receiving patient information and tag information mapped to the patient information, and receiving location information of a tag that is received from the RTLS server; an extractor extracting location information of respective patients based on the location information of the tag; and a transmitter transmitting the location information of respective patients through a network; wherein the health screening room PC includes: a controller corresponding patient information, based on reservation information of a patient received from the EMR server, and tag information mapped to the patient information to the RTLS server; a transmitter, under the control of the controller, transmitting the patient information and the tag information mapped to the patient information to the RTLS server; and a receiver receiving location information of a reserved patient who enters the health screening room from the RTLS server; and wherein the manager PC includes: a receiver receiving the location information of a patient from the RTLS server; a controller controlling a display unit to display a location of the patient in a hospital based on the location information of a patient received by the receiver; and the display unit displaying the location of the patient to be seen to a manager under the control of the controller.

### DESCRIPTION OF DRAWINGS

The above and other objects, features and other advantages of the present invention will be more clearly understood from the following detailed description taken in conjunction with the accompanying drawings, in which:

FIG. 1 is a view schematically illustrating an RFID-based EMR linking system according to an embodiment of the present invention;

FIG. 2 is a view illustrating configuration of the RFID-based EMR linking system according to an embodiment of the present invention;

FIG. 3 is a block diagram illustrating RTLS server 20 of FIG. 2;

FIG. 4 is a block diagram illustrating a health screening room PC 50;

FIG. 5 is a block diagram illustrating a manager PC 40;

FIG. 6 is a view illustrating location of a patient displayed by the manager PC 40; and

FIG. 7 is a view illustrating location of a patient displayed by the health screening room PC 50.

### DESCRIPTION OF REFERENCE NUMERALS FOR MAIN COMPONENTS OF THE DRAWINGS

| | |
|---|---|
| 11: RFID tag | 12: exciter |
| 13: AP | 14: hub |
| 20: RTLS server | 21: tag location receiver |
| 22: location information extractor | 23: storage |
| 24: reservation No. searching unit | 25: transmitter |
| 30: EMR server | 40: manager PC |
| 41: location information receiver | 42: controller |
| 43: display unit | 50: health screening room PC |
| 51: transceiver | 52: controller |
| 53: display unit | |

### [Mode for Invention]

Hereinafter, exemplary embodiments of the present invention will be described in detail with reference to accompanying drawings.

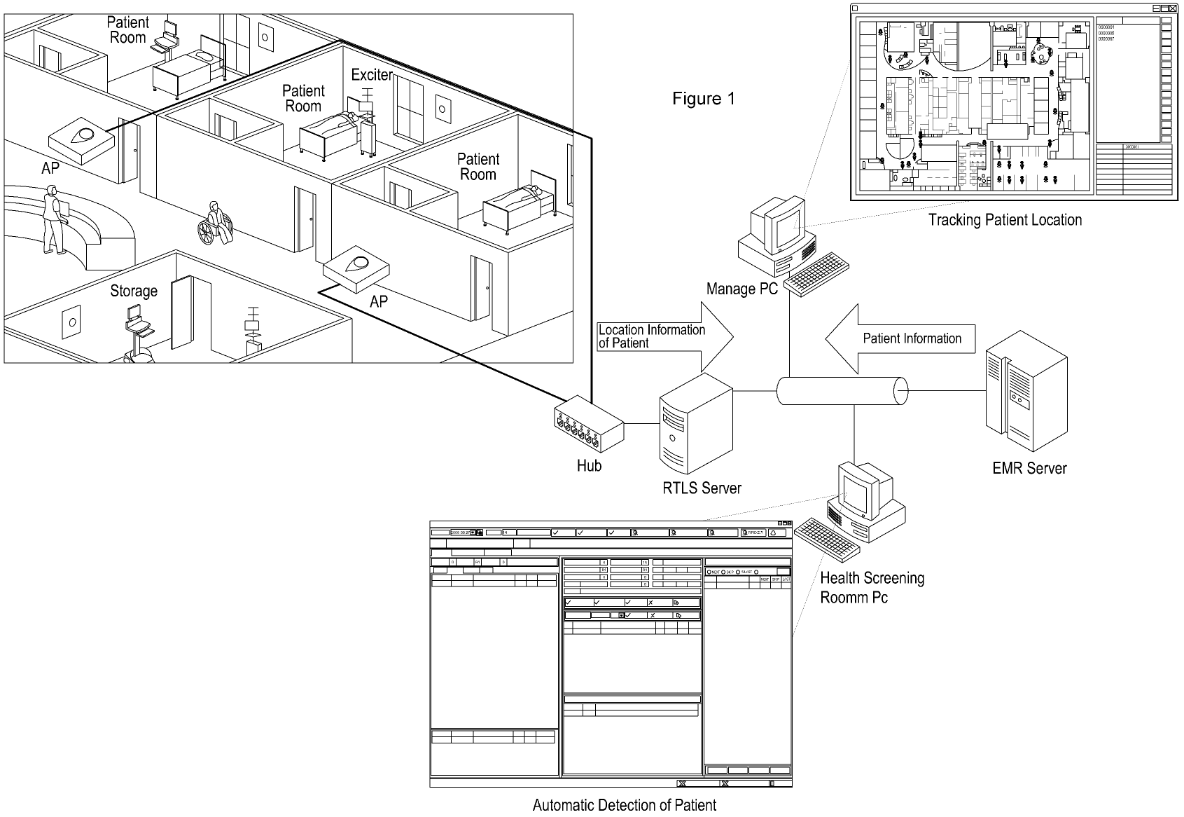

FIG. 1 is a view schematically illustrating an RFID-based EMR linking system according to an embodiment of the present invention.

As illustrated, in the RFID-based EMR linking system according to the embodiment of the present invention, a plurality of access points (hereinafter, referred to ‘AP’) detects a signal from an RFID tag attached to a patient gown, when a patient moves on a passage, calculates the location of the patient and transmits the calculated location of the patient to an RTLS server. When the patient is in a health screening room, the tag attached to the patient gown is detected by an exciter installed in the health screening room and the exciter transmits the detected information to the RTLS server through the APs.

The RTLS server calculates and detects the location of the patient using the received data. The detected location of the patient may be transmitted to a manager PC to be used in tracking the location of the patient and may be transmitted to a health screening room PC to be used in automatic detecting the patient.

Hereinafter, the RFID-based EMR linking system according to the embodiment of the present invention will be described in detail.

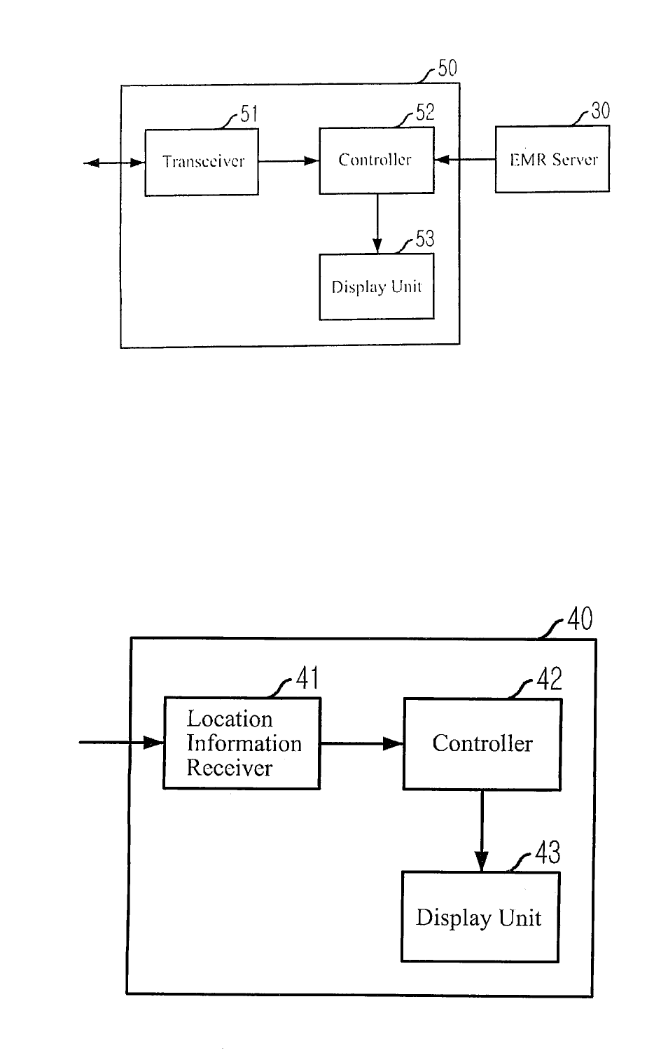

FIG. 2 is a view illustrating configuration of the RFID-based EMR linking system according to an embodiment of the present invention.

As illustrated, the system includes a plurality of RFID tags 11, at least one exciter 12 detecting the tag 11 of a patient in a health screening room, at least one AP 13 detecting the tag 11 of a patient in a passage, and a hub 14 relaying the plurality of APs 13. As illustrated, the plurality of APs 13 is connected to the single hub via wired line. Tags 11, exciters 12, APs 13, and a hub 14 may form a group A or B (here, let's call the groups in which wireless data transmission is carried out between the RFID tags 11, the APs 13, and the exciters 12 as ‘RFID unit’) like groups A and B of FIG. 2. For example, when there is a single hub on a single story, a single RFID unit is generated. That is, FIG. 2 shows two RFID units on two stories. Although FIG. 2 shows two RFID units, the number of the RFIDs is not limited thereto.

The exciter 12 is installed in a health screening room and serves to detect the RFID tag 11 of a patient who enters the health screening room. The APs 13 are installed around a passage and serves to track movement of the RFID tag 11 of the patient. Here, the APs 13 and the exciter 12 receive data from RFID tag 11 of the patient may be any device performing the function of receiving data from the RFID tag 11.

Wireless transmission of data between the RFID tag 11, the APs 13, and the exciter 12 in the RFID unit is already known and its description will be omitted.

Several hubs 14 are prepared to connect the plurality of APs 13 to each other, preferably by local area network (LAN).

The RFID-based EMR linking system includes an RTLS server 20, an EMR server 30, a manager PC 40, and a plurality of health screening room PCs 50. The RTLS server 20 receives the location of the tag 11 detected by the RFID unit to acquire location information of the patient and links the location information to EMRs of the manager PC 40 and the health screening room PCs 50. The manager PC 40 tracks the location of the patient using the location information acquired by the RTLS server 20 and the health screening room PCs 50 may automatically detect the patient using the location information acquired by the RTLS server 20.

The EMR server 30 stores EMR of a hospital.

The RTLS server 20, the EMR server 30, the manager PC 40, and the plurality of health screening room PCs 50 are generally connected to each other through LAN or in other manner.

Hereinafter, the detail configuration of the RTLS server 20 will be described with reference to the accompanying drawings.

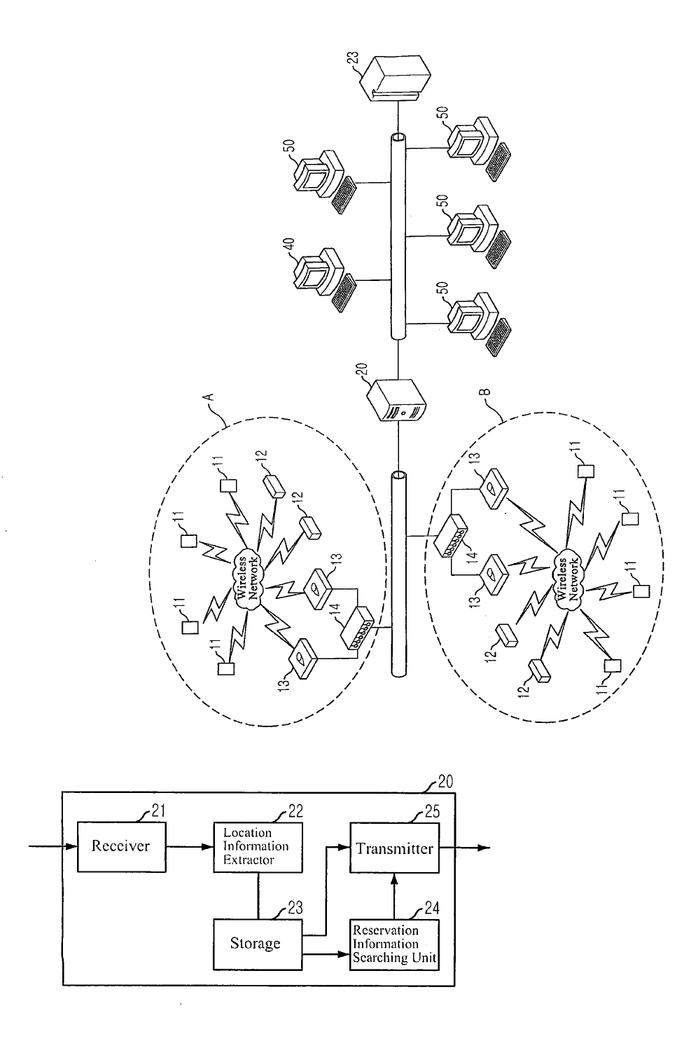

FIG. 3 is a block diagram illustrating RTLS server 20 of FIG. 2.

As illustrated, the RTLS server 20 includes a receiver 21, a location information extractor 22, a storage 23, a reservation information searching unit 24, and a transmitter 25.

The receiver 21 receives information about a patient and tag information given to the patient from the manager PC 40. The receiver 21 receives locations of tags 11 of respective patients detected by the exciter 12 or the APs 13.

The location information extractor 22 extracts location information of a patient from the tag location received by the receiver 21. The storage 23 stores location information of patients extracted by the location information extractor 22 and reservation information of patients. The reservation information searching unit 24 searches for reservation information of a patient who enters the health screening room in the storage 23 based on the location information of the patient. The transmitter 25 transmits the location information of the patient extracted by the location information extractor 22 and the reservation information of the patient searched by the reservation information searching unit 24 to the manager PC 40 or the health screening room PCs 50.

FIG. 4 is a block diagram illustrating a health screening room PC 50.

As illustrated, each of the health screening room PCs 50 includes a transceiver 51, a controller 52, and a display unit 53. In this embodiment of the present invention, the health screening room PC 50 includes only the above-mentioned elements, but this is a list for the illustrative purpose of the RFID-based EMR linking system and the rest may be identical to those of known PC.

The health screening room PC 50, when a patient enters the health screening room, checks the tag information of the RFID tag 11 of the patient, searches for EMR of the patient in the EMR server 30, and links the tag information to the searched EMR to display the linked data on the display unit 53. Hereinafter, detailed operation will be described as follows.

The transceiver 51 receives the tag information of the patient who enters the health screening room from the RTLS server 20. The controller 52, based on the tag information received by the transceiver 51, searches for patient information of the corresponding patient in the EMR server 30 and links the patient information to the EMR to display the patient information linked to the EMR on the display unit 53.

The display unit 53 displays the EMR linked with the patient location by the controller 52 such that a health screener may read the patient location-linked EMR. FIG. 5 is a block diagram illustrating a manager PC 40.

As illustrated in FIG. 5, the manager PC 40 displays the location information of a patient and includes a location information receiver 41, a controller 42, and a display unit 43. In this embodiment of the present invention, the manager PC 40 includes only the above-mentioned elements, but this is a list for the illustrative purpose of the RFID-based EMR linking system and the rest may be identical to those of known PC.

The location information receiver 41 receives the location information of a patient from the RTLS server 20. The controller 42 controls the display unit 43 of the manager PC 40 to display the location information received by the location information receiver 41. To this end, the controller 42 may store a simplified structure of a hospital and may control the display unit 43 to display the patient location such that a manager may recognize where the patient is in the simplified structure.

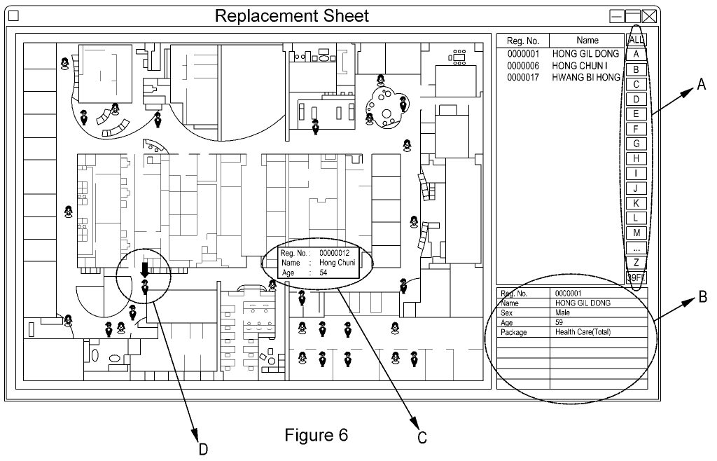

FIG. 6 is a view illustrating location of a patient displayed by the manager PC 40.

As illustrated, when a list of patients appears in a right window and when a patient is selected from the list, an arrow of a preset color (for example, light green) D is marked on an image at which the patient is and detail information B of the patient is displayed on the right lower side.

The list of patients may be filtered by selecting a right tab B. Like ‘C’ of FIG. 6, when an input device such as a mouse is positioned on a patient image on the drawing, brief information of a corresponding patient may be displayed by a pop-up window.

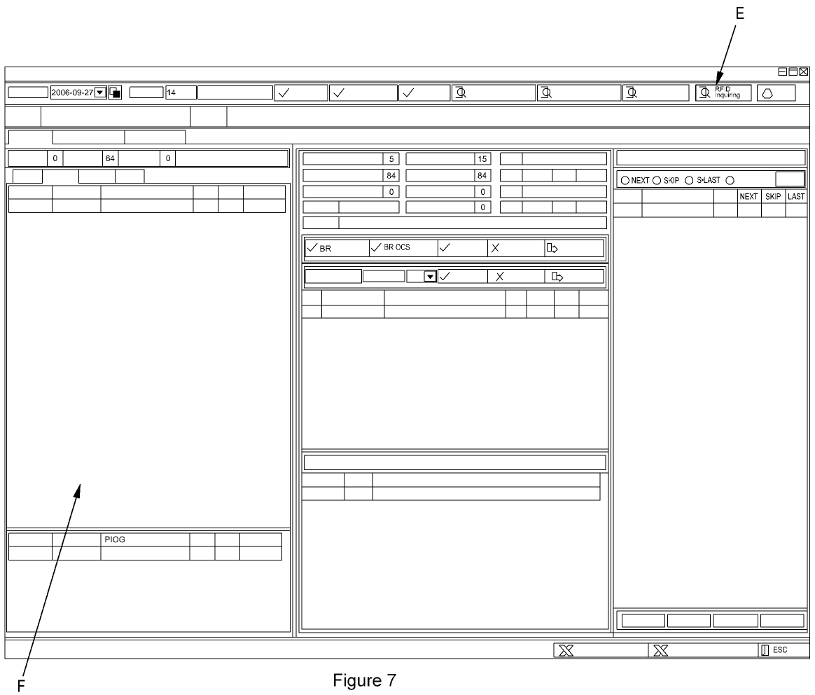

FIG. 7 is a view illustrating location of a patient displayed by the health screening room PC 50.

As illustrated, when a health screener of the health screening room clicks an RFID inquiring button E, information of a patient who enters the health screening room at the present may be displayed on a window F. Since other EMR jobs are identical to existing EMR functions, the description will be omitted.

As described above, according to the present invention, the location of a patient who has a tag is tracked using the RTLS and the location is linked to the EMR to detect the location of a patient in real time, so that the RFID-based EMR linked system may manage the moving line and the location of the patient.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

### FIG. 1

[symbol] TRACKING PATIENT LOCATION
[symbol] PC: MANAGE PC
[symbol] LOCATION INFORMATION OF PATIENT
[symbol] PATIENT INFORMATION
EMR [symbol] EMR SERVER
[symbol] HUB
RTLS [symbol] RTLS SERVER
[symbol] PC: HEALTH SCREENING ROOM PC
[symbol] EXCITER
[symbol] AUTOMATIC DETECTION OF PATIENT

### FIG. 2

[symbol] WIRELESS NETWORK

### FIG. 3

21: RECEIVER
22: LOCATION INFORMATION EXTRACTOR
23: STORAGE
25: TRANSMITTER
24: RESERVATION INFORMATION SEARCHING UNIT

### FIG. 4

51: TRANSCEIVER
52: CONTROLLER
53: DISPLAY UNIT
30: EMR SERVER

### FIG. 5

41: LOCATION INFORMATION RECEIVER
42: CONTROLLER
43: DISPLAY UNIT

### FIG. 6

[symbol] REG. NO.
[symbol] NAME
[symbol] ALL
[symbol] GENDER
[symbol] MALE
[symbol] AGE
[symbol] HEALTH CARE (TOTAL)

### FIG. 7

[symbol]

1. An RFID-based EMR linked apparatus comprising:
a receiver receiving patient information about a patient and tag information mapped to the patient information, and receiving location information of the tag possessed by the patient that is detected by an RFID through a network;
an extractor extracting location information of respective patients based on the location information of the tag; and
a transmitter transmitting the location information of the respective patients through the network.

2. The RFID-based EMR linked apparatus as set forth in claim 1, further comprising:
a storage storing the location information and reservation information of the respective patients; and
a searching unit searching for the reservation information of a patient based on the location information of the respective patients.

3. An RFID-based EMR linking system linked to an EMR server for storing EMRs of patients and an RTLS server for acquiring location information of patients based on RFID through a network, the system comprising:
a receiver receiving the location information of a patient who enters a health screening room from the RTLS server; and
a controller, based on the location information of the patient received by the receiver, searching for reservation information of a corresponding patient from the EMR server to link the searched reservation information to EMR of the corresponding patient.

4. The RFID-based EMR linking system as set forth in claim 4, further comprising a display unit displaying the EMR to a health screener,
wherein, the controller controls the display unit to display the patient who enters the health screening room on the EMR of the display unit using the location information of the patient.

5. An RFID-based EMR linking system linked to an EMR server for storing EMRs of patients and an RTLS server for acquiring location information of patients based on RFID through a network, the system comprising:
a receiver receiving the location information of a patient from the RTLS server;
a controller, based on the location information of the patient received by the receiver, controlling a display unit to display the location of the patient in a hospital; and
the display unit displaying the location of the patient under the control of the controller to be seen to a manager.

6. An RFID-based EMR linking system comprising:
an RFID unit receiving a wireless signal from an RFID tag possessed by a patient and transmitting location information of the RFID tag;
an EMR server storing EMRs of patients;
an RTLS server acquiring location information of a patient based on the location information received by the RFID unit;
a health screening room PC automatically detecting a patient who enters a heal screening room using the location information of the patient acquired by the RTLS server; and
a manager PC tracking the location of the patient using the location information of the patient acquired by the RTLS server;
wherein the RTLS server comprises:
a receiver receiving patient information and tag information mapped to the patient information, and receiving location information of a tag that is received from the RTLS server;
an extractor extracting location information of respective patients based on the location information of the tag; and
a transmitter transmitting the location information of respective patients through a network;
wherein the health screening room PC comprises:
a controller corresponding patient information, based on reservation information of a patient received from the EMR server, and tag information mapped to the patient information to the RTLS server;
a transmitter, under the control of the controller, transmitting the patient information and the tag information mapped to the patient information to the RTLS server; and
a receiver receiving location information of a reserved patient who enters the health screening room from the RTLS server; and
wherein the manager PC comprises:
a receiver receiving the location information of a patient from the RTLS server;
a controller controlling a display unit to display a location of the patient in a hospital based on the location information of a patient received by the receiver; and
the display unit displaying the location of the patient to be seen to a manager under the control of the controller.
